(19) United States
(12) Patent Application Publication
(10) Pub. No.: US 2020/0113380 A1
(43) Pub. Date: Apr. 16, 2020

(54) AIR FRYER

(71) Applicant: Shenzhen Mingxiang Electrical Appliances Co., Ltd., Shenzhen (CN)

(72) Inventor: Yankun LU, Zhongshan (CN)

(21) Appl. No.: 16/407,984

(22) Filed: May 9, 2019

(30) Foreign Application Priority Data
Oct. 12, 2018 (CN) 201811188760.4

(51) Int. Cl. A47J 37/04; A23L 5/10; A47J 37/06

(52) U.S. Cl. CPC A47J 37/041; A47J 37/0641; A23L 5/17; A23L 5/12

(57) ABSTRACT

Disclosed is an air fryer, including: an air fryer body; a carrier and/or a stirring paddle; a driving mechanism, which is detachably mounted outside the air fryer body, can be detachably connected with the carrier and/or the stirring paddle and can drive the carrier and/or the stirring paddle to rotate.

### CROSS-REFERENCE TO RELATED APPLICATIONS AND CLAIM TO PRIORITY

This application is related to Patent Application No. 201811188760.4 filed Oct. 12, 2018 in China, the disclosure of which is incorporated herein by reference and to which priority is claimed.

### FIELD

The disclosure relates to the field of fryers, and in particular to an air fryer.

### BACKGROUND

As is well-known, an air fryer is favored by people since it makes delicious food with less oil and no heat. The air fryer mainly heats food by hot air. If the food is placed and fixed in the air fryer, a side where the food is less in contact with the air is less heated, leading to uneven heating of the food and failure to meet the needs of users.

Therefore, there are some air fryers available on the market that are drivable to turn over the food. These air fryers are mainly provided with a reversible carrier movably arranged in a cavity of the air fryer and driven to rotate by a motor inside the air fryer. These air fryers can meet the requirement of turning food over. However, since the motor driving the carrier to rotate is arranged inside the air fryer, a user needs to disassemble the whole air fryer to repair or replace parts if the motor or a transmission mechanism is damaged, leading to inconvenience in maintenance. Moreover, in case of the motor or the transmission mechanism being damaged, the user cannot drive the carrier to rotate, and the food is heated unevenly due to failure to turn over the food, which seriously affects the user's cooking.

### SUMMARY

In order to solve the above-mentioned problems, an object of the disclosure is to provide an air fryer which is simple in structure and allows a carrier overturning driving mechanism to be freely switched.

In order to solve the technical problems, the technical solution of the disclosure is as follows.

There is provided an air fryer, including:

an air fryer body with an inner cavity for heating food;

a carrier for carrying food to be cooked so as to drive the food to rotate relative to the air fryer body and/or a stirring paddle for stirring the food in the cavity, which are/is rotatably mounted inside the cavity;

a driving mechanism detachably mounted outside the air fryer body and detachably connected with the carrier and/or the stirring paddle so as to drive the carrier and/or the stirring paddle to rotate.

In some embodiments, the air fryer further comprises a rotating shaft movably arranged in the cavity, and the carrier and/or the stirring paddle are/is arranged on the rotating shaft to rotate synchronously with the rotating shaft.

In some embodiments, the driving mechanism is a handle detachably mounted outside the air fryer body, and the handle is capable of being detachably connected with the rotating shaft to drive the rotating shaft which in turn brings the carrier and/or the stirring paddle to rotate synchronously.

In some embodiments a driving joint for connecting the handle and the rotating shaft is arranged between the handle and the rotating shaft.

In some embodiments, the driving joint is movably mounted at a side wall of the air fryer body, the driving joint is connected with the rotating shaft at one end and provided with a clamping groove at the other end away from the rotating shaft, and the handle is provided with an insertion portion which is capable of inserting into and connecting with the clamping groove.

In some embodiments, the driving joint is fixedly connected with the handle at one end and provided with a groove into which the rotating shaft is capable of being inserted at the other end away from the handle.

In some embodiments, the driving mechanism comprises a driving housing detachably mounted at a peripheral wall of the air fryer body, the driving housing is provided with a driving shaft which is detachably connected with the rotating shaft and connected with a motor for driving the driving shaft to rotate.

In some embodiments, at least one connecting mechanism comprising a clamping hole and a clamping column which are matched and clamped to each other is arranged between the driving housing and the air fryer body, the driving housing is detachably mounted at an outer surface side wall of the air fryer body by the connecting mechanism; one of the clamping hole and the clamping column is arranged at the outer surface side wall of the air fryer body, and the other one is arranged at the driving housing.

In some embodiments, a driving joint for connecting the driving shaft and the rotating shaft is arranged between the driving shaft and the rotating shaft.

In some embodiments, the driving joint, which is movably mounted at the side wall of the air fryer body, is connected with the rotating shaft at one end and provided with a clamping groove, into which the driving shaft is capable of being inserted, at the other end away from the rotating shaft.

The disclosure has the beneficial effects as follows.

Since the driving mechanism which drives the carrier and/or the stirring paddle to rotate is detachably arranged at a peripheral side wall of the air fryer body, the user can switch the driving mechanism freely according to needs to ensure that the driving mechanism can effectively drive the carrier and/or the stirring paddle to rotate, thereby solving the technical problem that a traditional air fryer cannot drive the carrier and/or the stirring paddle to rotate or turn over as the driving mechanism is damaged, facilitating the maintenance or replacement of the driving mechanism by the user conveniently, reducing the maintenance cost for the user greatly, and meeting the requirements of the user.

### BRIEF DESCRIPTION OF THE DRAWINGS

The disclosure will be further described in combination with accompanying drawings and preferred embodiments.

FIG. 1 is a structural sketch of a first preferred embodiment of the disclosure;

FIG. 2 is a structural sketch of a second preferred embodiment of the disclosure;

FIG. 3 is a structural diagram of the first preferred embodiment of the disclosure;

FIG. 4 is an exploded structural diagram of the first preferred embodiment of the disclosure;

FIG. 5 is a structural diagram of the second preferred embodiment of the disclosure;

FIG. 6 is an exploded structural diagram of the second preferred embodiment of the disclosure;

FIG. 7 is a view showing parts of a driving mechanism according to the second preferred embodiment of the disclosure; and

FIG. 8 is a view showing parts of a driving mechanism according to the second preferred embodiment of the disclosure.

### DETAILED DESCRIPTION OF THE EMBODIMENTS

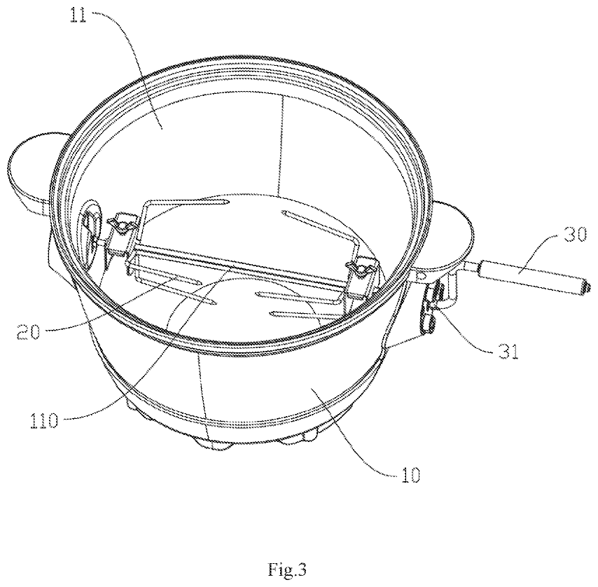

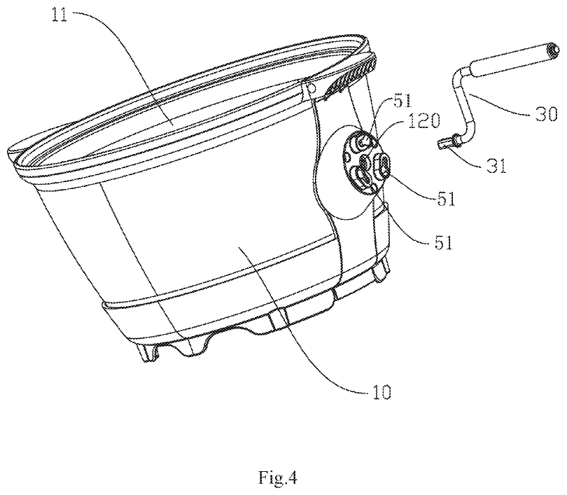

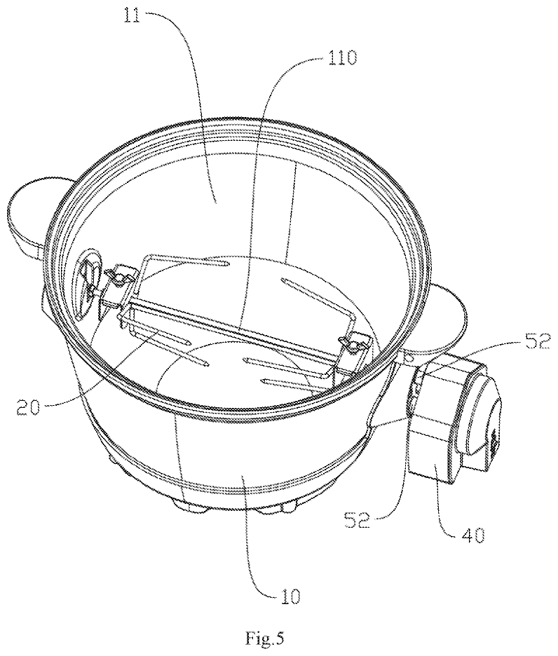

Referring to FIGS. 1, 3 and 4, a first preferred embodiment of the disclosure provides an air fryer, including an air fryer body 10 with a cavity 11 for heating food, a carrier 20 and/or a stirring paddle (not shown in the figures) rotatably mounted within the cavity 11 and a driving mechanism. The carrier 20 is used for carrying food to be cooked and can drive the food to rotate relative to the air fryer body 10. The stirring paddle is used for stirring the food placed in the cavity 11. The driving mechanism is detachably mounted outside the air fryer body 10, can be detachably connected with the carrier 20 and/or the stirring paddle and can drive the carrier 20 and/or the stirring paddle to rotate.

Since the driving mechanism which drives the carrier 20 and/or the stirring paddle to rotate is detachably arranged outside the air fryer body 10, that is, the driving mechanism is detachably mounted at a peripheral side wall of the air fryer body 10, the user can switch the driving mechanism freely according to needs to ensure that the driving mechanism can effectively drive the carrier 20 and/or the stirring paddle to rotate, thereby solving the technical problem that a traditional air fryer cannot drive the carrier 20 and/or the stirring paddle to rotate or turn over as the driving mechanism is damaged, facilitating the maintenance or replacement of the driving mechanism by the user conveniently, reducing the maintenance cost for the user greatly, and meeting the requirements of the user.

In order to enable the air fryer of the disclosure to be simpler in structure, preferably, the air fryer further comprises a rotating shaft 110 movably arranged in the cavity 11, and the carrier 20 and/or the stirring paddle are/is arranged on the rotating shaft to rotate synchronously with the rotating shaft 110. In the embodiment, the driving mechanism is a handle 30 detachably mounted outside the air fryer body 10. The handle 30 can be detachably connected with the rotating shaft 110 and can drive the rotating shaft 110 to drive the carrier 20 and/or the stirring paddle to rotate synchronously.

Further, in order to enable the handle 30 to be better connected with the rotating shaft 110, as a preferred embodiment of the disclosure, a driving joint 12 for connecting the handle 30 and the rotating shaft 110 is arranged between the handle 30 and the rotating shaft 110. In the embodiment, the driving joint 12 is movably mounted at a side wall of the air fryer body 10, the driving joint 12 is connected with the rotating shaft 110 at one end and provided with a clamping groove 120 at the other end away from the rotating shaft 110, and the handle 30 is provided with an insertion portion 31 which is capable of inserting into and connecting with the clamping groove 120.

Certainly, it is also possible that the driving joint 12 is fixedly connected with the handle 30 at one end and provided with a groove into which the rotating shaft 110 is inserted at the other end away from the handle 30, which can be specifically determined according to actual needs.

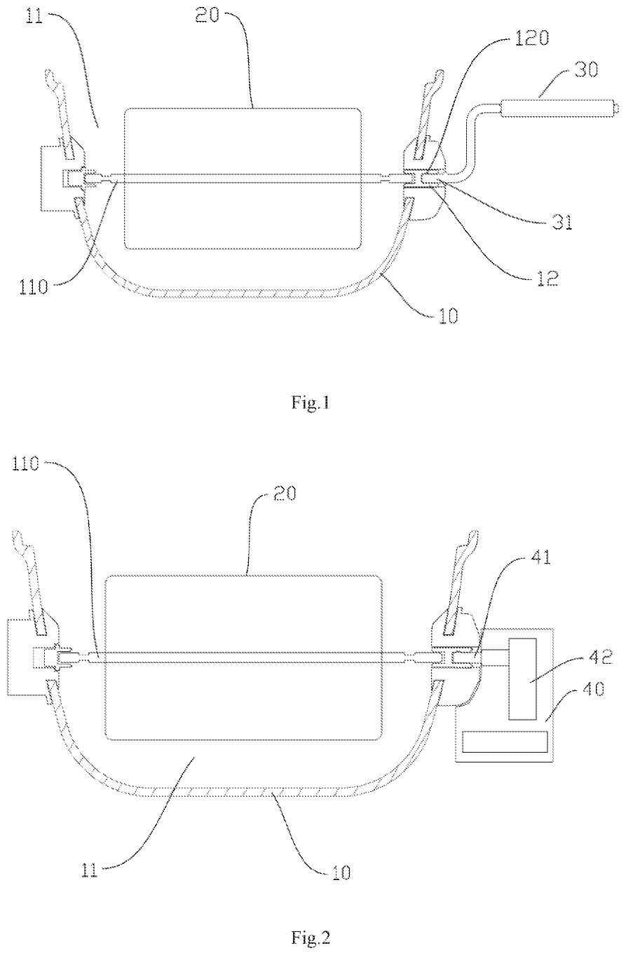

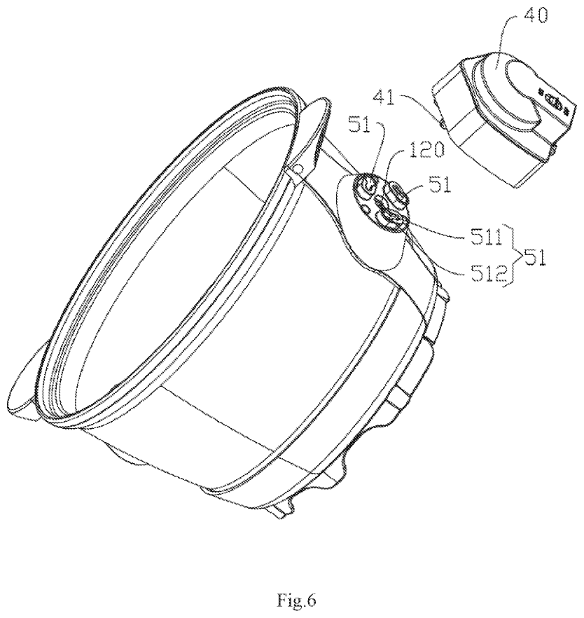

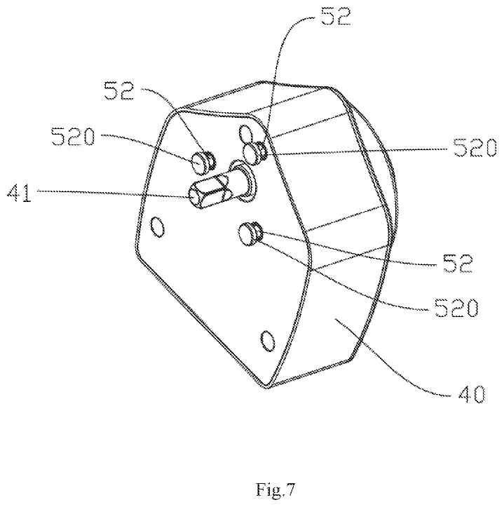

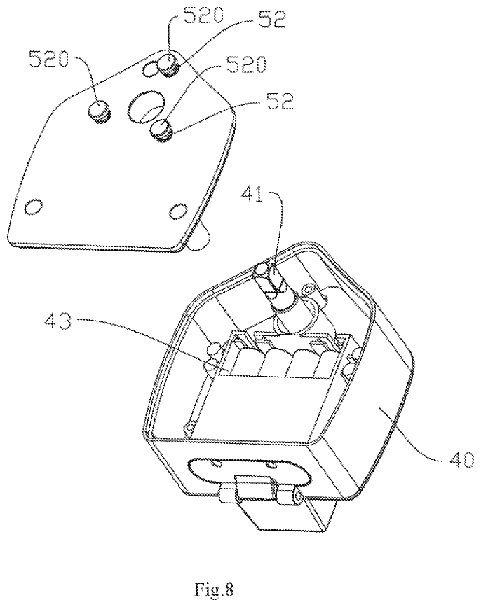

Referring to FIGS. 2, 5, 6, 7 and 8, the second preferred embodiment of the present disclosure differs from the first preferred embodiment with respect to the specific structure of the driving mechanism. In this embodiment, the driving mechanism includes a driving housing 40 detachably mounted at the peripheral wall of the air fryer body 10, the driving housing 40 is provided with a driving shaft 41 which is detachably connected with the rotating shaft 110 and connected with a motor 42 for driving the driving shaft 41 to rotate.

In order to enable the driving mechanism to be more conveniently mounted at the peripheral wall of the air fryer body 10, preferably, at least one connecting mechanism comprising a clamping hole 51 and a clamping column 52 which are matched and clamped to each other is arranged between the driving housing 40 and the air fryer body 10, the driving housing 40 is detachably mounted at an outer surface side wall of the air fryer body 10 by the connecting mechanism. One of the clamping hole 51 and the clamping column 52 is arranged at the outer surface side wall of the air fryer body 10, and the other one is arranged at the driving housing 40. In the embodiment, the clamping hole 51 is arranged at the outer surface side wall of the air fryer body 10, and the clamping column 52 is arranged at the driving housing 40. Certainly, it is also possible that the clamping hole 51 is arranged at the driving housing 40 and the clamping column 52 is arranged at the outer surface side wall of the air fryer body 10, which can be specifically determined according to actual needs.

In order to enable the clamping column 52 to be better matched and clamped with the clamping hole 51, the clamping hole 51 is a diameter-variable hole in the embodiment formed by enclosing and splicing a small-diameter hole 511 and a large-diameter hole 512. The clamping column 52 is provided with a bulge 520 at one end thereof which can be inserted into the large-diameter hole 512 and matched and clamped with the small-diameter hole 511. By inserting the bulge 520 of the clamping column 52 into the large-diameter hole 512 and horizontally sliding into the small-diameter hole 511, the bulge 520 can be clamped with the small-diameter hole 511 to further prevent the clamping column 52 from falling out of the clamping hole 51, thereby achieving simplicity and convenience.

In order to enable the driving mechanism to be more stably mounted at the peripheral wall of the air fryer body 10, preferably, three connecting mechanisms are arranged between the driving housing 40 and the air fryer body 10 and uniformly distributed around the outer periphery of the rotating shaft 110.

In addition, in order to enable the handle 41 to be better detachably connected with the rotating shaft 110, as a preferred embodiment, a driving joint 12 for connecting a driving shaft 41 and the rotating shaft 110 is arranged between the driving shaft 41 and the rotating shaft 110. Further preferably, the driving joint 12 is movably mounted at the side wall of the air fryer body 10. The driving joint 12 is connected with the rotating shaft 110 at one end and provided with a clamping groove 120 into which the driving shaft 41 is inserted at the other end away from the rotating shaft 110.

Certainly, it is also possible that the driving joint 12 is fixedly connected with the driving shaft 41 at one end thereof and provided with a groove into which the rotating shaft 110 is inserted at the other end away from the driving shaft 41, which can be specifically determined according to actual needs.

In addition, in order to better supply power to the motor 42, the driving housing 40 comprises a cavity 43 for containing a storage battery, within which a dry battery, a lithium battery and the like that supplies power to the motor 42 can be placed. and certainly, the motor 42 may also be connected with an external power source by an electrical lead, depending on actual needs, which can be specifically determined according to actual needs.

The described above are only preferred embodiments of the disclosure, and any technical solution for realizing the purpose of the disclosure by basically the same means shall fall within the scope of protection of the disclosure.

1. An air fryer, comprising:
an air fryer body with an inner cavity for heating food;
a carrier for carrying food to be cooked so as to drive the food to rotate relative to the air fryer body and/or a stirring paddle for stirring the food in the cavity, which are/is rotatably mounted inside the cavity;
a driving mechanism detachably mounted outside the air fryer body and detachably connected with the carrier and/or the stirring paddle so as to drive the carrier and/or the stirring paddle to rotate.

2. The air fryer of claim 1, further comprising a rotating shaft movably arranged in the cavity, and the carrier and/or the stirring paddle are/is arranged on the rotating shaft to rotate synchronously with the rotating shaft.

3. The air fryer of claim 2, wherein the driving mechanism is a handle detachably mounted outside the air fryer body, and the handle is capable of being detachably connected with the rotating shaft to drive the rotating shaft which in turn brings the carrier and/or the stirring paddle to rotate synchronously.

4. The air fryer of claim 3, wherein a driving joint for connecting the handle and the rotating shaft is arranged between the handle and the rotating shaft.

5. The air fryer of claim 4, wherein the driving joint is movably mounted at a side wall of the air fryer body, the driving joint is connected with the rotating shaft at one end and provided with a clamping groove at the other end away from the rotating shaft, and the handle is provided with an insertion portion which is capable of inserting into and connecting with the clamping groove.

6. The air fryer of claim 4, wherein the driving joint is fixedly connected with the handle at one end and provided with a groove into which the rotating shaft is capable of being inserted at the other end away from the handle.

7. The air fryer of claim 2, wherein the driving mechanism comprises a driving housing detachably mounted at a peripheral wall of the air fryer body, the driving housing is provided with a driving shaft which is detachably connected with the rotating shaft and connected with a motor for driving the driving shaft to rotate.

8. The air fryer of claim 7, wherein at least one connecting mechanism comprising a clamping hole and a clamping column which are matched and clamped to each other is arranged between the driving housing and the air fryer body, the driving housing is detachably mounted at an outer surface side wall of the air fryer body by the connecting mechanism; one of the clamping hole and the clamping column is arranged at the outer surface side wall of the air fryer body, and the other one is arranged at the driving housing.

9. The air fryer of claim 7, wherein a driving joint for connecting the driving shaft and the rotating shaft is arranged between the driving shaft and the rotating shaft.

10. The air fryer of claim 9, wherein the driving joint, which is movably mounted at the side wall of the air fryer body, is connected with the rotating shaft at one end and provided with a clamping groove, into which the driving shaft is capable of being inserted, at the other end away from the rotating shaft.
